(19) United States
(12) Patent Application Publication
(10) Pub. No.: US 2008/0170522 A1
(43) Pub. Date: Jul. 17, 2008

(54) METHOD AND APPARATUS FOR INDICATING A TRANSMISSION STATUS TO A HIGHER LAYER

(75) Inventors: Mohammed Sammour, Montreal (CA); Ana Lucia Pinheiro, West Chester, PA (US); Shankar Somasundaram, Deer Park, NY (US); Stephen E. Terry, Northport, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/970,167

(22) Filed: Jan. 7, 2008

Related U.S. Application Data
(60) Provisional application No. 60/883,685, filed on Jan. 5, 2007.

(51) Int. Cl. H04B 7/00

(52) U.S. Cl. 370/310

(57) ABSTRACT

A method and apparatus for indicating a transmission status to a higher layer are disclosed. In the transmitting entity, a radio link control (RLC) entity sends a packet delivery notification regarding delivery status of a higher layer message to a higher layer entity based on hybrid automatic repeat request (HARQ) feedback information obtained from an HARQ entity. The RLC entity may send the packet delivery notification to the higher layer entity based on an RLC status report. Alternatively, the HARQ entity may send the packet delivery notification to the higher layer entity and/or the RLC entity based on HARQ feedback. The higher layer entity may update the higher layer message before retransmitting the higher layer message. If the RLC entity segments an RLC service data unit (SDU) and delivery of at least one segment of the RLC SDU fails, the RLC entity may discard the RLC SDU.

### CROSS REFERENCE TO RELATED APPLICATION

This application claims the benefit of U.S. provisional application No. 60/883,685 filed Jan. 5, 2007, which is incorporated by reference as if fully set forth.

### FIELD OF INVENTION

The present invention is related to wireless communication.

### BACKGROUND

FIG. 1 shows a user plane protocol stack in a user equipment (UE) and a network, (i.e., an evolved Node-B (eNode-B)), in a third generation partnership project (3GPP) long term evolution (LTE) system. The UE includes a packet data convergence protocol (PDCP) layer, a radio link control (RLC) layer, a medium access control (MAC) layer and a physical layer. The eNode-B includes a PDCP layer, an RLC layer, a MAC layer and a physical layer.

FIG. 2 shows a control plane protocol stack in a UE and a network, (i.e., an eNode-B and a mobility management entity (MME)), in the 3GPP LTE system. The UE includes a non-access stratum (NAS) layer, a radio resource control (RRC) layer, a PDCP layer, an RLC layer, a MAC layer, and a physical layer. The eNode-B includes an RRC layer, a PDCP layer, an RLC layer, a MAC layer, and a physical layer, and the MME includes an NAS layer.

For the LTE user-plane, the PDCP layer resides above the RLC layer, which resides above the MAC layer. For the LTE control-plane, the RRC layer resides above the PDCP layer, which resides above the RLC layer, which resides above the MAC layer. In 3GPP high speed packet access (HSPA), (i.e., high speed uplink packet access (HSUPA) and high speed downlink packet access (HSDPA)), and HSPA enhancements, for control-plane, the RRC layer resides above the RLC layer, which resides above the MAC layer. The order of the layers for HSPA user-plane is similar to LTE, (i.e., PDCP resides above RLC which resides above MAC).

Header compression and security functions are performed at the PDCP layer. Automatic repeat request (ARQ) functionality is performed at the RLC layer. The RLC layer at the transmitting side retransmits a failed packet based on ARQ positive acknowledgement (ACK) or negative acknowledgement (NACK) feedback from the RLC layer at the receiving side. The ARQ ACK/NACK feedback is typically included in an RLC status report in 3GPP Release 6. Hybrid automatic repeat request (HARQ) functionality is performed at the MAC layer. The HARQ entity at the transmitting side retransmits a packet based on HARQ feedback, (i.e., ACK or NACK), from the HARQ entity at the receiving side.

The RLC layer includes three different modes of RLC entities: a transparent mode (TM) RLC entity, an unacknowledged mode (UM) RLC entity, and an acknowledged mode (AM) RLC entity. The TM RLC entity does not provide retransmission service, (i.e., there is no ARQ). Service data unit (SDU) segmentation and reassembly may be supported, but there is no additional RLC protocol data unit (PDU) header overhead, since all SDU segments are transmitted in the same transmission time interval (TTI). The UM RLC entity does not provide retransmission service, (i.e., there is no ARQ), but may provide other RLC services, such as inserting RLC PDU headers for segmentation and reassembly, concatenation, padding and ciphering. The AM RLC entity provides all services provided by the UM RLC entity plus in-sequence delivery and error correction via retransmissions using ARQ.

The RLC layer informs a higher layer of discarded packets, (i.e., discarded RLC SDU), if the RLC SDU is discarded at the RLC layer due to RLC re-establishment, RLC reset, or expiration of a timer in the RLC layer. The RLC layer also informs the higher layer of “unrecoverable error” if the RLC layer in the transmitting side exhausts the maximum number of transmissions for the packet. An AM RLC entity in the transmitting side informs the higher layer of the successful reception of the RLC SDU by the AM RLC entity in the receiving side, if the RLC SDU is positively acknowledged by the status PDU.

In HARQ assisted ARQ operation, The RLC layer uses knowledge obtained from the HARQ entity about the transmission and reception status of a transport block (TB). If the HARQ transmitter detects a failed delivery of a TB, (e.g., due to maximum retransmission limit is reached), the HARQ entity notifies the delivery failure of the TB to the RLC entity, and the RLC entity initiates retransmission and/or re-segmentation of an RLC PDU.

There are many signaling procedures between the UE and the network including layer 3 signaling procedures, (such as RRC signaling procedures and NAS signaling procedures), and layer 2 signaling procedures, (such as MAC control signaling or RLC related signaling procedure, such as RLC reset procedure). The layer 2 and 3 signaling procedures rely on exchange of signaling messages between different nodes or signaling peers, such as a Node B and a UE. The signaling messages may be in the form of request message, response message, confirm message, or any message form. The signaling procedures may employ a timer-based retransmission mechanism. For example, if a response message is not received within a specified time period, a corresponding request message is retransmitted. Certain RRC procedures, (such as RRC connection request and cell update), require retransmission of the message in case the UE does not get an RRC response before a timer expires.

Timely execution of such control plane, (e.g., RRC), or user plane, (e.g., RLC or MAC), signaling procedures is a critical factor in achieving speedy and reliable communications. Failure in the delivery of such signaling messages should be avoided and recovered timely.

### SUMMARY

A method and apparatus for indicating a transmission status to a higher layer are disclosed. In the transmitting entity, an RLC entity sends a packet delivery notification regarding delivery status of a higher layer message to a higher layer entity based on HARQ feedback information obtained from an HARQ entity in a MAC entity. The RLC entity may send the packet delivery notification to the higher layer entity based on an RLC status report. Alternatively, the HARQ entity may send the packet delivery notification to the higher layer entity and/or the RLC entity based on HARQ feedback. The higher layer entity may update the higher layer message before retransmitting the higher layer message. If the RLC entity segments an RLC SDU and delivery of at least one segment of the RLC SDU fails, the RLC entity may discard the RLC SDU.

### BRIEF DESCRIPTION OF THE DRAWINGS

A more detailed understanding may be had from the following description, given by way of example and to be understood in conjunction with the accompanying drawings wherein:

FIG. 1 shows a user-plane protocol stack in a UE and a network in a 3GPP LTE system;

FIG. 2 shows a control plane protocol stack in a UE and a network in a 3GPP LTE system; and

FIG. 3 shows an example transmitting entity.

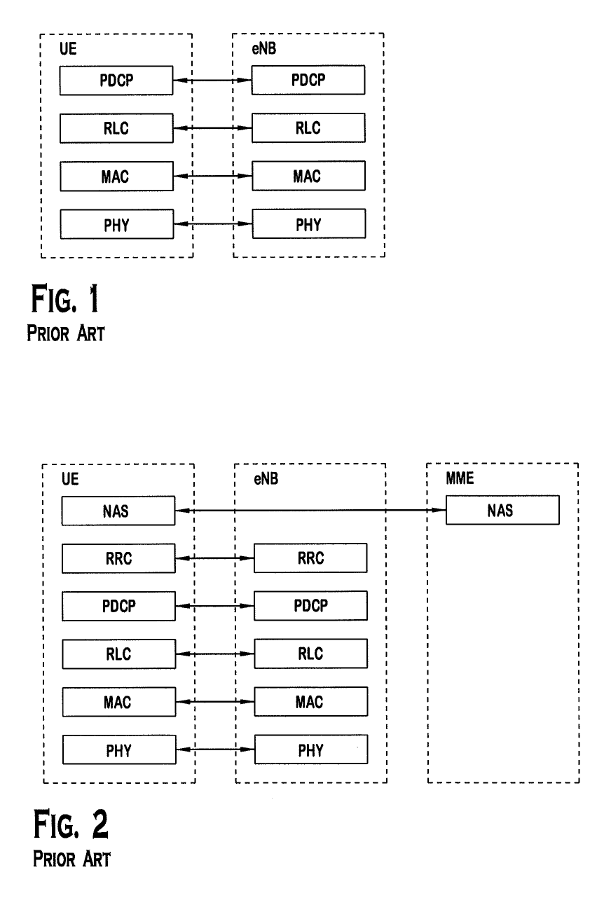

### DETAILED DESCRIPTION

When referred to hereafter, the terminology “wireless transmit/receive unit (WTRU)” includes but is not limited to a UE, a mobile station, a fixed or mobile subscriber unit, a pager, a cellular telephone, a personal digital assistant (PDA), a computer, or any other type of user device capable of operating in a wireless environment. When referred to hereafter, the terminology “Node-B” includes but is not limited to a base station, a site controller, an access point (AP), or any other type of interfacing device capable of operating in a wireless environment.

When referred to hereinafter, the terminology “packet delivery notification” is used to describe notification in the events of success or failure of packet delivery to a communication peer. Embodiments described herein are applicable to any wireless communication systems including, but not limited to, 3GPP, LTE, or high speed packet access (HSPA) enhancements (HSPA+).

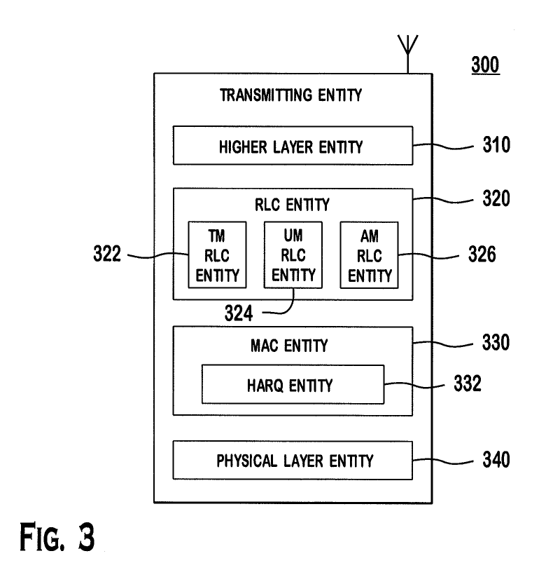

FIG. 3 shows an example transmitting entity 300. The transmitting entity 300 may include a higher layer entity 310, an RLC entity 320, a MAC entity 330, and a physical layer entity 340. The transmitting entity 300 may be a WTRU or a network. The RLC entity 320 may include a TM RLC entity 322, an UM RLC entity 324 and/or an AM RLC entity 326. The MAC entity 330 includes an HARQ entity 332. The higher layer entity 310 may be a PDCP layer, an RRC layer, an NAS layer, or any other layer/entity. More specifically, in case of control-plane, for HSPA, the higher entity is an RRC layer, and for LTE, the higher entity is first a PDCP layer and then an RRC layer. In case of user-plane, the higher entity is a PDCP layer.

The RLC entity 320 receives a higher layer message from the higher layer entity 310 and sends an RLC PDU to the MAC entity 330. The higher layer message may correspond to or may be referred to as a “higher layer PDU” or an “RLC SDU.” The MAC entity 330 then generates a transport block carrying the RLC PDU and sends the transport block to the physical layer entity 340. The HARQ entity 332 implements an HARQ mechanism for transmission and retransmission of the transport block.

The RLC entity 320, (TM, UM, or AM RLC entity), provides a packet delivery notification to the higher layer entity 310 to indicate whether the higher layer message was successfully or unsuccessfully delivered to a receiving entity based on HARQ ACK/NACK feedback, (i.e., HARQ assisted RLC operation). The packet delivery notification may be sent to notify whenever delivery success or failure is determined. Alternatively, the packet delivery notification may be sent only when one event but not the other occurs, (i.e., a conditional notification). For example, the packet delivery notification may be sent to notify only in case of failure, but not in case of success. The HARQ entity 332 informs the RLC entity 320 of the successful or unsuccessful delivery of a transport block (TB) based on the HARQ ACK/NACK feedback. For example, if the maximum number of HARQ retransmissions is reached before successful delivery of a TB, the HARQ entity 332 informs the RLC entity 320 of the failed HARQ transmission of the TB. The RLC entity 320 then informs the higher layer entity 310 of the failed transmission of the higher layer message, (e.g., the HARQ entity 332 to the RLC entity 320 to the PDCP layer to the RRC layer, or the HARQ entity 332 to the RLC entity 320 to the RRC layer). Alternatively, the HARQ entity 332 may directly inform the higher layer entity 310 of the successful or unsuccessful delivery of the higher layer message based on the HARQ ACK/NACK feedback, (e.g., the HARQ entity 332 to the RRC layer).

Conventionally, an AM RLC entity 326 informs the higher layer entity 310 of the successful delivery of an RLC SDU if the RLC SDU is positively acknowledged by the RLC status report that is sent from the receiving entity. The AM RLC entity 326 may utilize the RLC status report in addition to the HARQ ACK/NACK feedback as an input to trigger the packet delivery notification. The AM RLC entity 326 may provide the packet delivery notification to the higher layer entity 310 based only on the HARQ ACK/NACK feedback, or based on both the RLC status report and the HARQ ACK/NACK feedback, (e.g., whichever happens first).

Optionally, the packet delivery notification may accompany “reason” or “cause” of unsuccessful delivery of the higher layer message. For example, the RLC entity 320 may indicate to the higher layer entity 310 that packet delivery failed (or that the packet was discarded) because the maximum number of HARQ retransmissions has reached.

The notification of successful transmission by the RLC entity 320 based on RLC status report is currently used by some of the RRC procedures to indicate successful completion of the RRC procedures. For example, a WTRU considers that a security procedure is complete when an RLC entity in a network confirms successful delivery of the SECURITY MODE COMPLETE message to the WTRU. The same confirmation is applied for other messages, such as the INITIAL DIRECT TRANSFER message, the SIGNALING CONNECTION RELEASE INDICATION message, and the HANDOVER FROM UTRAN FAILURE message. Since these messages do not require an RRC layer response, the RLC feedback is used to indicate that the procedure is complete. Conventionally, a negative confirmation from the RLC layer informing that the messages were not transmitted successfully does not trigger any action by the RRC entity in the transmitting entity.

In accordance with one embodiment, upon receiving the packet delivery notification from the RLC entity 320, (either triggered by the HARQ ACK/NACK feedback or RLC status report), the higher layer entity 310 may, in case of transmission failure, conduct a retransmission of the failed higher layer message. Alternatively, the higher layer entity 310 may choose to update the higher layer message before retransmitting the message. For example, in case of a delivery failure of an RRC measurement report message, the RRC layer may update the RRC measurement before retransmitting the RRC measurement message. This avoids that the information in the message to get ‘stale’ when a large number of retransmissions is required. In case of transmission failure of an NAS message, the RRC entity notifies the NAS entity of the packet delivery, and the NAS entity may take further action. In case of a successful transmission, the higher layer entity 310 may conclude that the underlying procedure was completed successfully. The higher layer entity 310 may use the packet delivery notification to trigger any other function, (i.e., a function that may not have to do with retransmission).

In general, the HARQ assisted signaling procedure may be applied to any signaling procedures, including layer 3 signaling procedures, (e.g., RRC signaling or NAS signaling procedures), and layer 2 signaling procedures, (e.g., MAC signaling or RLC signaling procedures). The HARQ entity 332 informs a relevant entity at the transmitting entity either directly or via an intermediary, (e.g., RLC entity). There may be more than one intermediary, (e.g., the HARQ entity 332 to the RLC entity 320 to the PDCP entity to the RRC entity).

For example, the HARQ entity 332 informs the RLC entity 320 of the successful or unsuccessful delivery of the underlying higher layer message or RLC PDU based on the HARQ ACK/NACK feedback. For example, if the maximum number of HARQ retransmissions is reached, (e.g., only HARQ NACKs have been received), and the HARQ entity 332 was unsuccessful in delivering a TB, the HARQ entity 332 informs the RLC entity 320 of the failed HARQ transmission. The RLC entity 320 (AM RLC entity) may retransmit the underlying higher layer message or RLC PDU. The RLC entity 320, (TM, UM or AM RLC entity), may inform the higher layer entity 310 of the failed transmission so that the failed transmission is recovered by the higher layer entity 310 and any necessary steps are performed by the higher layer entity 310.

Alternatively, the HARQ entity 332 may directly inform the higher layer entity 310 of the successful or unsuccessful delivery of the underlying higher layer message based on the HARQ ACK/NACK feedback. For example, if the maximum number of HARQ retransmissions is reached and the HARQ entity 332 was unsuccessful in delivering a TB, the HARQ entity 332 informs the higher layer entity 310 of the failed HARQ transmission.

Upon receiving the notification, the higher layer entity 310 may, in case of transmission failure, retransmit the failed message as soon as the higher layer entity 310 receives the delivery failure indication. For example, certain RRC procedures, (such as RRC connection request and cell update), require retransmission of the message in case the UE does not get an RRC response before a timer expires. The RRC entity may retransmit the RRC connection request message or cell update message when the RRC entity receives the delivery failure indication.

The higher layer entity 310 may update the message before retransmitting. For example, in case of a failure of an RRC measurement report message, the RRC layer may update the message contents before retransmitting it. This avoids the information in the message to get ‘stale’ when a large number of retransmissions is required. In case of transmission failure of an NAS message, the HARQ entity 332 may notify the NAS entity either directly or via intermediaries, (e.g., via RLC then RRC), which may then take further action. In case of a successful transmission, the higher layer entity 310 may conclude that the underlying procedure was completed successfully. The notification from the HARQ entity 332 may trigger any other function.

A MAC-related signaling procedure may also rely on the notification from the HARQ entity 332. This ensures faster retransmissions for any signaling message. The notification of a successful transmission from the HARQ entity 332 may also be used by the MAC entity 330 and the RLC entity 320 to decide on any further actions needed. This ensures faster retransmissions for any MAC and RLC signaling message, (such as any MAC control PDU or any RLC control PCU, for example, RLC reset PDU or RLC status PDU).

The higher layer message, (i.e., RLC SDU), may be segmented into multiple segments, (i.e., multiple RLC PDUs), at the RLC entity 320, (UM or AM RLC entity), of the transmitting entity 300, and be reassembled into the RLC SDU at an RLC entity of the receiving entity. If delivery of at least one segment has failed and if the failed segment will not be retransmitted further, other segments of the same higher layer message do not need to be transmitted or retransmitted because the reassembly procedure will eventually fail. Once the RLC entity 320, (UM or AM RLC entity), of the transmitting entity 300 knows either from the HARQ ACK/NACK feedback or the RLC status report that transmission of a segment of the higher layer message has failed, (e.g., due to reaching the maximum number of retransmissions), the RLC entity 320 may stop transmitting or retransmitting all other segments of the higher layer message. The RLC entity 320 may discard the remaining segments of the higher layer message. If some segments were already sent to the MAC entity 330 for transmission after discarding the segments at the RLC entity 320, the RLC entity 320 may inform the MAC entity 330, (i.e., the HARQ entity 332), to terminate the HARQ process for the segments, (i.e., not to transmit the segments).

Although the features and elements are described in particular combinations, each feature or element can be used alone without the other features and elements or in various combinations with or without other features and elements. The methods or flow charts provided may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method for indicating a transmission status to a higher layer, the method comprising:
a higher layer entity generating a higher layer message;
a radio link control (RLC) entity sending at least one RLC protocol data unit (PDU) carrying at least one segment of the higher layer message to a medium access control (MAC) entity;
the MAC entity transmitting at least one transport block carrying said at least one RLC PDU via a hybrid automatic repeat request (HARQ) entity; and
the RLC entity sending a packet delivery notification regarding delivery status of the higher layer message to the higher layer entity based on HARQ feedback information obtained from the HARQ entity.

2. The method of claim 1 further comprising:
the RLC entity sending the packet delivery notification to the higher layer entity based on an RLC status report.

3. The method of claim 1 wherein the RLC entity is a transparent mode (TM) RLC entity.

4. The method of claim 1 wherein the RLC entity is an unacknowledged mode (UM) RLC entity.

5. The method of claim 1 wherein the RLC entity is an acknowledged mode (AM) RLC entity.

6. The method of claim 1 wherein the packet delivery notification is generated when a maximum number of HARQ retransmissions is reached before successful delivery of a transport block carrying at least a segment of the higher layer message.

7. The method of claim 1 wherein the packet delivery notification is generated upon failed HARQ delivery of a transport block carrying at least a segment of the higher layer message.

8. The method of claim 1 wherein the packet delivery notification includes a cause of unsuccessful delivery of the higher layer message.

9. The method of claim 1 further comprising:
the higher layer entity conducting a retransmission of the higher layer message.

10. The method of claim 9 wherein the higher layer entity is a radio resource control (RRC) entity.

11. The method of claim 10 wherein the higher layer message is one of an RRC connection request message, a cell update message, a measurement report message, a security mode complete message, an initial direct transfer message, a signaling connection release indication message, and a handover failure message.

12. The method of claim 9 further comprising:
the higher layer entity updating the higher layer message before retransmitting the higher layer message.

13. The method of claim 1 further comprising:
the RLC entity segmenting an RLC service data unit (SDU) into multiple segments, wherein at least one segment is included in the RLC PDU.

14. The method of claim 13 further comprising:
the RLC entity discarding all segments of the RLC SDU if the packet delivery notification indicates that at least one segment of the RLC SDU is failed to be delivered.

15. The method of claim 14 further comprising:
the RLC entity notifying the HARQ entity to terminate an HARQ process for segments of the RLC SDU that are forwarded to the MAC entity.

16. A method for indicating a transmission status to a higher layer, the method comprising:
a higher layer entity generating a higher layer message;
a radio link control (RLC) entity sending at least one RLC protocol data unit (PDU) carrying at least one segment of the higher layer message to a medium access control (MAC) entity;
the MAC entity transmitting at least one transport block carrying said at least one RLC PDU via a hybrid automatic repeat request (HARQ) entity; and
the HARQ entity sending a packet delivery notification regarding delivery status of the higher layer message to at least one of the higher layer entity and the RLC entity based on HARQ feedback.

17. The method of claim 16 wherein the RLC entity is a transparent mode (TM) RLC entity.

18. The method of claim 16 wherein the RLC entity is an unacknowledged mode (UM) RLC entity.

19. The method of claim 16 wherein the RLC entity is an acknowledged mode (AM) RLC entity.

20. The method of claim 16 wherein the packet delivery notification is generated when a maximum number of HARQ retransmissions is reached before successful delivery of a transport block carrying at least a segment of the higher layer message.

21. The method of claim 16 wherein the packet delivery notification is generated upon failed HARQ delivery of a transport block carrying at least a segment of the higher layer message.

22. The method of claim 16 wherein the packet delivery notification includes a cause of unsuccessful delivery of the higher layer message.

23. The method of claim 16 further comprising:
the higher layer entity conducting a retransmission of the higher layer message.

24. The method of claim 23 wherein the higher layer entity is a radio resource control (RRC) entity.

25. The method of claim 24 wherein the higher layer message is one of an RRC connection request message, a cell update message, a measurement report message, a security mode complete message, an initial direct transfer message, a signaling connection release indication message, and a handover failure message.

26. The method of claim 23 further comprising:
the higher layer entity updating the higher layer message before retransmitting the higher layer message.

27. The method of claim 16 further comprising:
the RLC entity segmenting an RLC service data unit (SDU) into multiple segments, wherein at least one segment is included in the higher layer message.

28. The method of claim 27 further comprising:
the RLC entity discarding all segments of the RLC SDU if the packet delivery notification indicates that at least one segment of the RLC SDU is failed to be delivered.

29. The method of claim 28 further comprising:
the RLC entity notifying the HARQ entity to terminate an HARQ process for segments of the RLC SDU that are forwarded to the MAC entity.

30. The method of claim 16 further comprising:
the RLC entity retransmitting one of the higher layer message and the RLC PDU upon receipt of the packet delivery notification indicating unsuccessful delivery of the RLC PDU.

31. A wireless transmit/receive unit (WTRU) for transmitting a packet, the WTRU comprising:
a higher layer entity for generating a higher layer message;
a radio link control (RLC) entity configured to generate at least one RLC protocol data unit (PDU) carrying at least one segment of the higher layer message; and
a medium access control (MAC) entity configured to generate at least one transport block from said at least one RLC PDU received from the RLC entity, and transmit the TB via a hybrid automatic repeat request (HARQ) entity,
wherein the RLC entity is configured to send a packet delivery notification regarding delivery status of the higher layer message to the higher layer entity based on HARQ feedback information obtained from the HARQ entity.

32. The WTRU of claim 31 wherein the RLC entity is configured to send the packet delivery notification to the higher layer entity based on an RLC status report.

33. The WTRU of claim 31 wherein the RLC entity is a transparent mode (TM) RLC entity.

34. The WTRU of claim 31 wherein the RLC entity is an unacknowledged mode (UM) RLC entity.

35. The WTRU of claim 31 wherein the RLC entity is an acknowledged mode (AM) RLC entity.

36. The WTRU of claim 31 wherein the packet delivery notification is generated when a maximum number of HARQ retransmissions is reached before successful delivery of a transport block carrying at least a segment of the higher layer message.

37. The WTRU of claim 31 wherein the packet delivery notification is generated upon failed HARQ delivery of a transport block carrying at least a segment of the higher layer message.

38. The WTRU of claim 31 wherein the packet delivery notification includes a cause of unsuccessful delivery of the higher layer message.

39. The WTRU of claim 31 wherein the higher layer entity retransmits the higher layer message if the packet delivery notification indicates that at least a segment of the higher layer message is not successfully transmitted.

40. The WTRU of claim 39 wherein the higher layer entity is a radio resource control (RRC) entity.

41. The WTRU of claim 40 wherein the higher layer message is one of an RRC connection request message, a cell update message, a measurement report message, a security mode complete message, an initial direct transfer message, a signaling connection release indication message, and a handover failure message.

42. The WTRU of claim 39 wherein the higher layer entity updates the higher layer message before retransmitting the higher layer message.

43. The WTRU of claim 31 wherein the RLC entity is configured to segment an RLC service data unit (SDU) into multiple segments, wherein at least one segment is included in the RLC PDU.

44. The WTRU of claim 43 wherein the RLC entity is configured to discard all segments of the RLC SDU if the packet delivery notification indicates that at least one segment of the RLC SDU is failed to be delivered.

45. The WTRU of claim 44 wherein the RLC entity is configured to notify the HARQ entity to terminate an HARQ process for segments of the RLC SDU that are forwarded to the MAC entity.

46. A wireless transmit/receive unit (WTRU) for transmitting a packet, the WTRU comprising:
a higher layer entity for generating a higher layer message;
a radio link control (RLC) entity configured to generate at least one RLC protocol data unit (PDU) carrying at least one segment of the higher layer message; and
a medium access control (MAC) entity configured to generate at least one transport block from said at least one RLC PDU received from the RLC entity, and transmit the TB via a hybrid automatic repeat request (HARQ) entity, the HARQ entity being configured to send a packet delivery notification regarding delivery status of the higher layer message to at least one of the higher layer entity and the RLC entity based on HARQ feedback.

47. The WTRU of claim 46 wherein the RLC entity is a transparent mode (TM) RLC entity.

48. The WTRU of claim 46 wherein the RLC entity is an unacknowledged mode (UM) RLC entity.

49. The WTRU of claim 46 wherein the RLC entity is an acknowledged mode (AM) RLC entity.

50. The WTRU of claim 46 wherein the packet delivery notification is generated when a maximum number of HARQ retransmissions is reached before successful delivery of a transport block carrying at least a segment of the higher layer message.

51. The WTRU of claim 46 wherein the packet delivery notification is generated upon failed HARQ delivery of a transport block carrying at least a segment of the higher layer message.

52. The WTRU of claim 46 wherein the packet delivery notification includes a cause of unsuccessful delivery of the higher layer message.

53. The WTRU of claim 46 wherein the higher layer entity is configured to retransmit the higher layer message if the packet delivery notification indicates unsuccessful delivery of the higher layer message.

54. The WTRU of claim 53 wherein the higher layer entity is a radio resource control (RRC) entity.

55. The WTRU of claim 54 wherein the higher layer message is one of an RRC connection request message, a cell update message, a measurement report message, a security mode complete message, an initial direct transfer message, a signaling connection release indication message, and a handover failure message.

56. The WTRU of claim 53 wherein the higher layer entity is configured to update the higher layer message before retransmitting the higher layer message.

57. The WTRU of claim 46 wherein the RLC entity is configured to segment an RLC service data unit (SDU) into multiple segments, wherein at least one segment is included in the RLC PDU.

58. The WTRU of claim 57 wherein the RLC entity is configured to discard all segments of the RLC SDU if the packet delivery notification indicates that at least one segment of the RLC SDU is failed to be delivered.

59. The WTRU of claim 58 wherein the RLC entity is configured to notify the HARQ entity to terminate an HARQ process for segments of the RLC SDU that are forwarded to the MAC entity.

60. The WTRU of claim 46 wherein the RLC entity is configured to retransmit one of the higher layer message and the RLC PDU upon receipt of the packet delivery notification indicating unsuccessful delivery of the RLC PDU.

61. A Node-B for transmitting a packet, the Node-B comprising:
a radio link control (RLC) entity configured to generate at least one RLC protocol data unit (PDU) carrying at least one segment of a higher layer message; and
a medium access control (MAC) entity configured to generate at least one transport block (TB) from said at least one RLC PDU received from the RLC entity, and transmit the TB via a hybrid automatic repeat request (HARQ) entity,
wherein the RLC entity is configured to send a packet delivery notification regarding delivery status of the higher layer message to a higher layer entity based on HARQ feedback information obtained from the HARQ entity.

62. A Node-B for transmitting a packet, the Node-B comprising:
a radio link control (RLC) entity configured to generate at least one RLC protocol data unit (PDU) carrying at least one segment of a higher layer message; and
a medium access control (MAC) entity configured to generate at least one transport block (TB) from said at least one RLC PDU received from the RLC entity, and transmit the TB via a hybrid automatic repeat request (HARQ) entity, the HARQ entity being configured to send a packet delivery notification regarding delivery status of the higher layer message to at least one of a higher layer entity and the RLC entity based on HARQ feedback.

63. A method for transmitting a radio link control (RLC) service data unit (SDU), the method comprising:
an RLC entity segmenting an RLC SDU into multiple segments, wherein at least one segment is included in an RLC protocol data unit (PDU); and
the RLC entity discarding all segments of the RLC SDU if a packet delivery notification indicates that at least one segment of the RLC SDU is failed to be delivered.

64. A wireless transmit/receive unit (WTRU) for transmitting a radio link control (RLC) service data unit (SDU), the WTRU comprising:
an RLC entity configured to segment an RLC SDU into multiple segments and include at least one segment in an RLC protocol data unit (PDU), and discard all segments of the RLC SDU if a packet delivery notification indicates that at least one segment of the RLC SDU is failed to be delivered; and
a medium access control (MAC) entity to transmit the RLC PDU.
